(19) United States
(12) Patent Application Publication
(10) Pub. No.: US 2011/0024250 A1
(43) Pub. Date: Feb. 3, 2011

(54) Shock absorbing member

(75) Inventors: Masayuki Kitashiba, Aichi-ken (JP); Chiharu Totani, Aichi-ken (JP); Katsushi Ito, Aichi-ken (JP); Katsutoshi Mizuno, Aichi-Ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Kiyosu-shi (JP)

(21) Appl. No.: 12/801,188

(22) Filed: May 27, 2010

(30) Foreign Application Priority Data
Jul. 29, 2009 (JP) 2009-176538

(51) Int. Cl. F16F 9/00; F16F 9/10; F16F 9/30; F16F 7/00

(52) U.S. Cl. 188/376

(57) ABSTRACT

The present invention provides a shock absorbing member which includes a pair of opposing plates and a plurality of resin tubes internally filled with a viscous body. Both end surfaces of the resin tubes are closed by the pair of the plates. The each resin tube is disposed between the pair of the plates and is surrounded by a space not filled with the viscous body. When a shock in a direction of bringing the pair of the plates closer to each other is applied, the resin tube is buckled toward the surrounding space and the viscous body leaks out from a crack generated in the resin tube by the buckling to absorb the shock.

### TECHNICAL FIELD

The present invention relates to a shock absorbing member provided inside a bumper, a door trim, and a front pillar of an automobile to absorb crash energy produced in a crash or the like.

### BACKGROUND ART

A shock absorbing member is provided in a bumper for an automobile to enhance the shock absorbing effect in case of a crash of the vehicle. Examples of the shock absorbing member include a resin elastic body (Patent Literature 1) and a member internally including a resin rib (that absorbs a shock by buckling and cracking). Another example of the shock absorbing member internally includes a hollow portion fully filled with a viscous body (Patent Literature 2). A through hole leading to the outside of the shock absorbing member is provided in a wall portion defining the hollow portion. When a shock is applied, the viscous body passes through the through hole to absorb a shock by friction (viscous resistance).

### CITATION LIST

### Patent Literature

Patent Literature 1: Japanese Patent Application Publication No. JP-A-H10-181484

Patent Literature 2: Japanese Patent Application Publication No. JP-A-H09-254727

### SUMMARY OF INVENTION

### Technical Problem

However, the shock absorbing member formed by a resin elastic body (Patent Literature 1) and the shock absorbing member with a resin rib (that absorbs a shock by buckling and cracking) are required to be considerably thick in order to provide a sufficient shock absorbing effect, and thus do not contribute to space saving. In the shock absorbing member filled with a viscous body (Patent Literature 2), the hollow portion is fully filled with a viscous body, and therefore without modification, the shock absorbing member is not easily collapsed even when a shock is applied. Accordingly, the through hole described above is provided to make the shock absorbing member easily collapsible. In this case, however, it is necessary to provide, in addition to the through hole, a leakage prevention structure that prevents the viscous body from leaking from the through hole during normal times, which complicates the structure.

It is therefore an object of the present invention to provide a shock absorbing member that can efficiently absorb a shock with a small thickness and that is sufficiently easily collapsible.

### Solution to Problem

In order to achieve the foregoing object, the present invention provides a shock absorbing member including: a pair of opposing plates; and a plurality of resin tubes internally filled with a viscous body and each surrounded by a space not filled with the viscous body, the resin tubes being provided between the pair of the plates and both end surfaces of the resin tubes being closed by the pair of the plates, in which when a shock in a direction of bringing the pair of the plates closer to each other is applied, the resin tube is buckled toward the surrounding space and the viscous body leaks out from a crack generated in the resin tube by the buckling to absorb the shock.

The plurality of resin tubes filled with the viscous body are not specifically limited, and may be as exemplified in (i) and (ii) below.

(i) The plurality of resin tubes filled with the viscous body may be part of a plurality of resin tubes forming respective cells of a grid-like resin rib that are selected so as to be arranged discontinuously (like scattered islands).

(ii) The plurality of resin tubes filled with the viscous body may be isolated from each other with tube walls thereof not coupled to each other.

In the case of (i) above, the grid shape of the grid-like resin rib is not specifically limited, and may be a triangular grid, a quadrangular grid, a hexagonal grid (honeycomb grid), or the like.

In the shock absorbing member, one of the pair of plates and the plurality of resin tubes filled with the viscous body are preferably, but not necessarily, integrally formed from a resin.

The viscous body is not specifically limited. Example of the viscous body include volatile liquids such as water and various kinds of organic solvents, non-volatile liquids such as liquid paraffin and water glass, plasticizing agents such as oil, glycols, glycerol, and DOP, high-viscosity liquids such as starch syrup, resins that are liquid at normal temperatures, and grease, slurry obtained by dispersing powder of various kinds in sol, water, or an organic solvent, and a viscous body obtained by adding at least oil to a thermoplastic elastomer.

### Advantageous Effects of Invention

When a shock is applied to the shock absorbing member according to the present invention, the resin tube is buckled and the viscous body leaks out from a crack generated in the resin tube by the buckling, so that the shock can be absorbed efficiently. The resin tube is buckled toward a surrounding space which is not filled with the viscous body, and thus is sufficiently easily collapsible.

### BRIEF DESCRIPTION OF DRAWINGS

FIG. 1 is a perspective view showing a shock absorbing member according to an embodiment of the present invention;

FIG. 2A is a cross-sectional plan view of the shock absorbing member according to the embodiment;

FIG. 2B is a cross-sectional plan view of the shock absorbing member with a shock being applied thereto;

FIG. 3A is a plan view of an apparatus used to conduct a shock absorption test on the shock absorbing member according to the embodiment;

FIG. 3B is a side view of the apparatus;

FIG. 3C is an enlarged cross-sectional plan view of the apparatus during the shock absorption test;

FIG. 4 shows the results of the shock absorption test conducted on shock absorbing members according to the embodiment and comparative examples 1 and 2 and shock absorbing members as existing products 1 and 2.

FIG. 5A is a cross-sectional front view of the shock absorbing member according to the embodiment;

FIG. 5B is a cross-sectional front view of a shock absorbing member according to a modified example 1;

FIG. 6A is a cross-sectional front view of a shock absorbing member according to a modified example 2;

FIG. 6B is a cross-sectional front view of a shock absorbing member according to a modified example 3;

FIG. 7A is a cross-sectional front view of a shock absorbing member according to a modified example 4; and

FIG. 7B is a cross-sectional front view of a shock absorbing member according to a modified example 5.

### DESCRIPTION OF EMBODIMENTS

### Embodiment

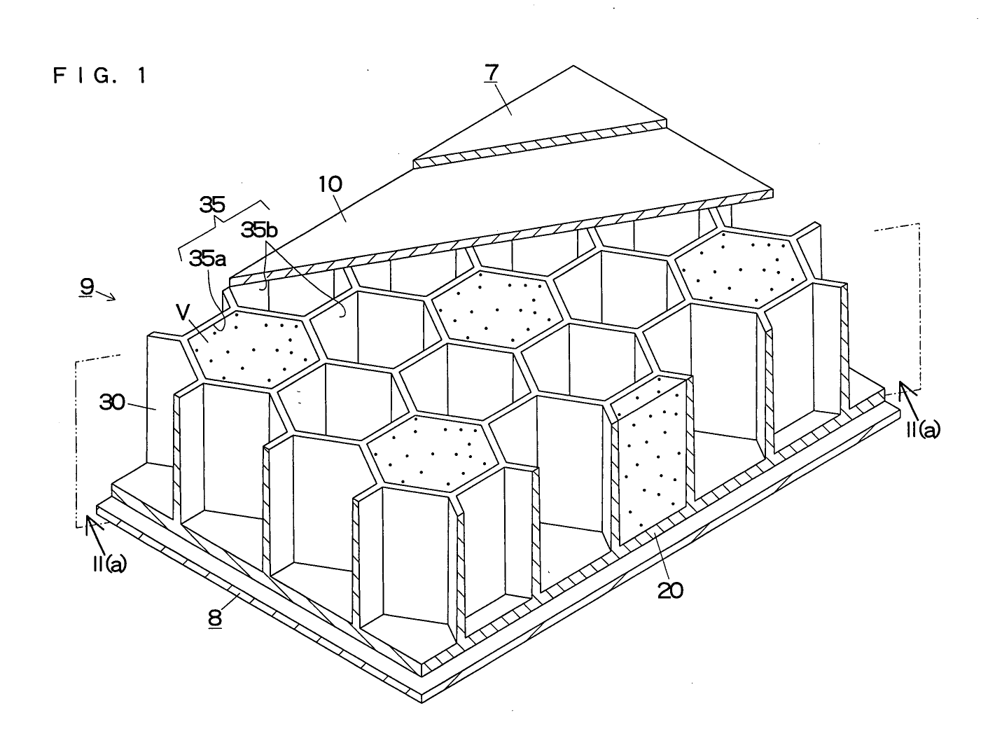

A shock absorbing member 9 according to an embodiment shown in FIGS. 1 to 4 and 5A is attached between a bumper fascia 7 and a bumper reinforcement 8. The shock absorbing member 9 includes a front plate 10, a back plate 20, and a grid-like resin rib 30 to be described below.

The front plate 10 and the back plate 20 are arranged at an interval in the front-rear direction. The front surface of the front plate 10 contacts the rear surface of the bumper fascia 7 (or is disposed in rear of the bumper fascia 7 at an interval). The rear surface of the back plate 20 contacts the front surface of the bumper reinforcement 8. The front plate 10 and the back plate 20 are formed by injection molding using PP (polypropylene) containing a carbon filler as a raw material.

The grid-like resin rib 30 is formed integrally with the back plate 20 by injection molding, and projects forward from the front surface of the back plate 20. The grid-like resin rib 30 has a hexagonal grid (honeycomb grid) shape as viewed from the front, and respective cells of the hexagonal grid form resin tubes 35, 35, . . . . Of the resin tubes 35, 35, . . . , one-fourth of the resin tubes, 35a, 35a, . . . , which are selected so as to be arranged discontinuously, are filled with a viscous body V, and the remaining three-fourths of the resin tubes, 35b, 35b, . . . , are not filled with the viscous body V. The rear surface of the front plate 10 is joined to the front end of the grid-like resin rib 30 by welding in this state to close the resin tubes 35, 35, . . . .

The viscous body V is formed by adding oil to a thermoplastic elastomer. The thermoplastic elastomer is not specifically limited. Examples of the thermoplastic elastomer include olefinic elastomers, styrene elastomers such as SEBS (styrene-ethylene-butylene-styrene), SEPS (styrene-ethylene-propylene-styrene), and SEEPS (styrene-ethylene-ethylene-propylene-styrene), urethane elastomers such as TPU, and ester elastomers such as TPEE. The oil added to the thermoplastic elastomer is not specifically limited. Examples of the oil include paraffin oil, naphthene oil, and aromatic oil.

Besides the oil, low-viscosity PP (with an average molecular weight of about 50000) and a foaming agent (such as PP foam particles, PU foam particles, and foam particles formed from an acrylic resin containing butane) may be added to the thermoplastic elastomer. In this case, the energy absorption amount can be increased. In the case where the low-viscosity PP is added, the low-viscosity PP imparts its bonding effect to the viscous body V so that the viscous body V is solid in a normal state with no shock applied but becomes fluid with the bonded portion ruptured when a shock is applied.

The shock absorbing member 9 according to the embodiment is not provided with a through hole that makes the shock absorbing member 9 easily collapsible and a leakage prevention structure that operates during normal times as in the shock absorbing member disclosed in Patent Literature 2. Also, no gap that allows leakage of the viscous body V is provided between the shock absorbing member 9 and the bumper reinforcement 8 (to which the shock absorbing member 9 is attached) as in the shock absorbing member disclosed in Patent Literature 2.

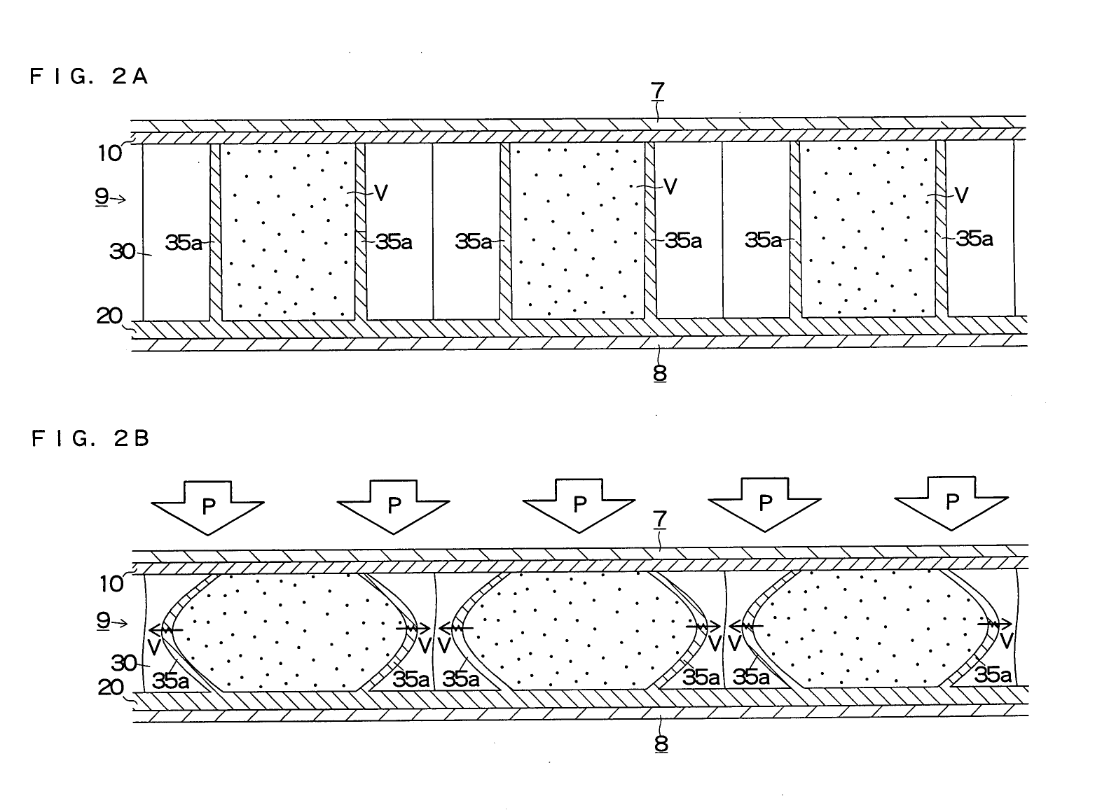

A case where a shock is applied to the shock absorbing member 9 is described next. When a shock P is applied from the front side toward the rear side of the front plate 10 as shown in FIG. 2B, the front plate 10 is curved to be displaced rearward at and around a portion of the front plate 10 to which the shock P is applied. In this event, the resin tube 35a filled with the viscous body V is buckled toward spaces inside the surrounding resin tubes 35b not filled with the viscous body V, and a crack is generated in the resin tube 35a. The viscous body V inside the resin tube 35a leaks out of the resin tube 35a through the crack to flow into the surrounding resin tubes 35b not filled with the viscous body V. The shock P is absorbed by the resistance against buckling of the resin tube 35a and the friction (flow resistance) during leakage of the viscous body V.

Now, a shock absorption test conducted to actually test the shock absorption performance of the shock absorbing member 9 according to the embodiment will be described.

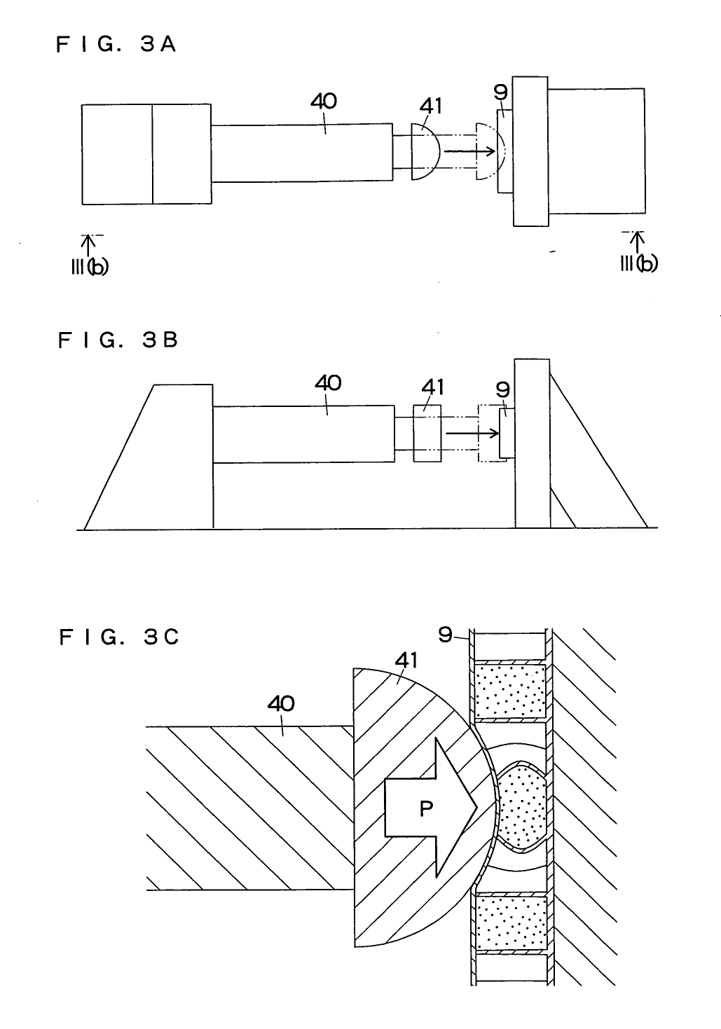

As shown in FIGS. 3A and 3B, a head 41 was protruded from a cylinder 40 to apply a shock to the shock absorbing member 9 according to the embodiment. The head 41 had a semi-cylindrical shape with a diameter of 120 mm, and the magnitude of the shock applied was 833.3 J (equivalent to 40 km/h).

The dimensions of the shock absorbing member 9 according to the embodiment subjected to the test were as follows. The thickness of the front plate 10 was 2 mm. The thickness of the back plate 20 was 3 mm. The distance between the front plate 10 and the back plate 20 (that is, the height of the grid-like resin rib 30) was 30 mm. Hence, the thickness of the shock absorbing member 9 (that is, the distance from the front surface of the front plate 10 to the rear surface of the back plate 20) was 35 mm. The distance between the centers of any two adjacent resin tubes 35, 35 of the grid-like resin rib 30 was 25 mm. The thickness of the grid-like resin rib 30 (resin tubes 35) was largest at 2.12 mm at an end on the side of the back plate 20, and gradually reduced toward the front plate 10 (with a draft of) 0.5° to become smallest at 1.6 mm at an end on the side of the front plate 10. Four different types were used as the raw material of the viscous body V (viscous body material) as given later in Cases 1 to 4 of Table 1.

The same test was also conducted on shock absorbing members according to comparative examples 1 and 2, which were different from the shock absorbing member according to the embodiment, and shock absorbing members as existing products 1 and 2. The shock absorbing members according to the comparative examples 1 and 2 were the same as the shock absorbing member 9 according to the embodiment, except for the arrangement of the resin tubes 35a filled with the viscous body. Specifically, the shock absorbing member according to the comparative example 1 was different from the shock absorbing member 9 according to the embodiment in that no resin tubes were filled with a viscous body. On the contrary, the shock absorbing member according to the comparative example 2 was different from the shock absorbing member 9 according to the embodiment in that all the resin tubes were filled with a viscous body. The shock absorbing members as the existing products 1 and 2 were a mass of foamed PP with an expansion rate of 20 times and with a thickness of 55 mm and 120 mm, respectively.

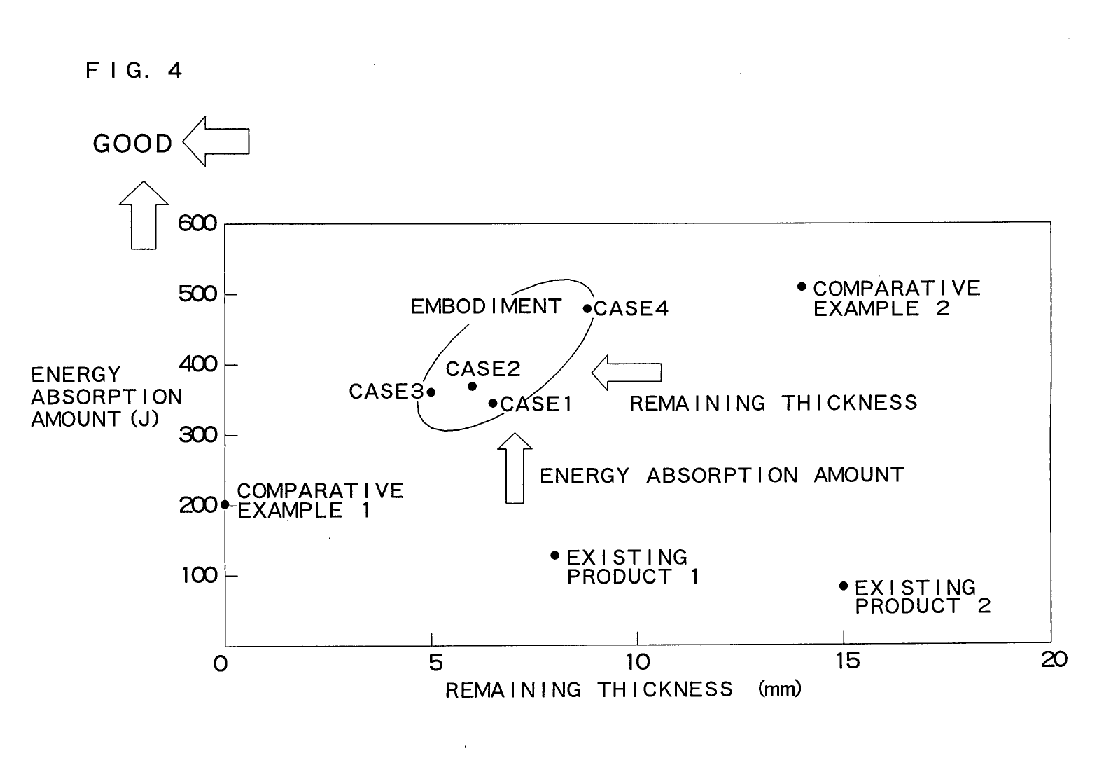

The specifications of the shock absorbing members are summarized in upper rows of Table 1 below. The results of the shock absorption test conducted on the shock absorbing members are summarized in lower rows of Table 1 and in FIG. 4. The solution viscosity (mPa·s) of the thermoplastic elastomer given in Table 1 was obtained by measuring the viscosity of a 10% toluene solution (30° C.) prepared by dissolving the thermoplastic elastomer (SEEPS) in toluene using a cone-plate viscometer. The viscosity (MFR g/10 min) of the PP given in Table 1 was obtained at a test temperature of 230° C. and a test load of 21.18 N (2.16 kgw).

TABLE 1

| Embodiment | | | | Comparative | Comparative | Existing | Existing |
|---|---|---|---|---|---|---|---|
| Case1 | Case2 | Case3 | Case4 | Example 1 | Example 2 | Product 1 | Product 2 |

| Base Structure | | | Grid-like resin rib | Grid-like | | Foamed PP | |
|---|---|---|---|---|---|---|---|
| | | | (honeycomb rib) | resin rib | | (expanded 20 | |
| | | | | (honeycomb rib) | | times) | |
| Thickness (mm) | | | 35 | 35 | | 55 | 120 |
| Arrangement of resin tubes | | | Discontinulusly arranged | None | All | — | — |
| filled with viscous body | | | (one-fourth of resin tubes) | | | | |
| Raw material | Thermo- | Type | SEEPS | — | Same as | — | — |
| of the | plastic | St amount | 30 | | Case 1 | | |
| Viscous body | elastomer | Solution viscosity (mPa · s) | 460 | | | | |

| | | | | |
|---|---|---|---|---|
| Amount added (parts by mass) | 50 | 30 | 50 | 30 |

| | | |
|---|---|---|
| Oil | Type | Paraffin oil |
| | Weight-averaged molecular | 540 |
| | weight | |

| | | | | |
|---|---|---|---|---|
| Amount added (parts by mass) | 50 | 70 | 50 | 70 |

| | | | | |
|---|---|---|---|---|
| PP | Viscosity (MFR g/10 min) | — | — | 500 |

| | | |
|---|---|---|
| Amount added (parts) | 5 | 10 |

| | | | | |
|---|---|---|---|---|
| Foaming | Type | — | — | Foam particles |
| agent | Amount added (parts by mass) | | | 5 |

| | | | | | | | | | |
|---|---|---|---|---|---|---|---|---|---|
| Test results | Remaining thickness (mm) | 6.5 | 6 | 5 | 8.8 | 0 | 14 | 8 | 15 |
| | Energy absorption amount (J) | 345 | 369 | 361 | 479 | 202 | 510 | 128 | 82.5 |

In the test, a shock absorbing member with a larger energy absorption amount (vertical axis of FIG. 4) and a smaller remaining thickness (horizontal axis of FIG. 4), that is, a shock absorbing member plotted on the chart of FIG. 4 at a position closer to the upper left corner is considered to be better. As can be seen from FIG. 4, the shock absorbing member 9 according to the embodiment (Cases 1 to 4) was plotted generally directly above the shock absorbing member as the existing product 1, and above and to the left of the shock absorbing member as the existing product 2. This indicates that the shock absorbing member 9 has better shock absorption performance than that of the shock absorbing members as the existing products 1 and 2. The shock absorbing member according to the comparative example 1 with no resin tubes filled with a viscous body is found to have a smaller remaining thickness (horizontal axis of FIG. 4) than that of the shock absorbing member 9 according to the embodiment and thus is better, but have a smaller energy absorption amount (vertical axis of FIG. 4) than that of the shock absorbing member 9 according to the embodiment. Meanwhile, the shock absorbing member according to the comparative example 2 with all the resin tubes filled with a viscous body (which is the same as the viscous body of Case 1) is found to have a larger energy absorption amount (vertical axis of FIG. 4) than that of the shock absorbing member 9 according to the embodiment (Case 1) and thus is better, but have a larger remaining thickness (horizontal axis of FIG. 4) than that of the shock absorbing member 9 according to the embodiment (Case 1). Hence, the shock absorbing member 9 according to the embodiment is found to achieve satisfactory, well-balanced results in the two evaluation criteria, namely the remaining thickness (horizontal axis of FIG. 4) and the energy absorption amount (vertical axis of FIG. 4) compared to the shock absorbing members according to the comparative examples 1 and 2.

According to the embodiment, the following effects [A] to [D] can be obtained.

[A] When a shock P is applied, the shock P can be absorbed efficiently with the resin tube 35a buckled and the viscous body V leaking out from a crack generated in the resin tube 35a by the buckling.

[B] When the shock P is applied, the resin tube 35a filled with the viscous body V is buckled toward spaces inside the resin tubes 35b not filled with the viscous body V. Thus, the shock absorbing member 9 is sufficiently easily collapsible (has a small remaining thickness after a crash) compared to a shock absorbing member with all the resin tubes 35, 35, . . . filled with the viscous body V (comparative example 2). Therefore, it is not absolutely necessary to provide a through hole that makes the shock absorbing member 9 easily collapsible and a leakage prevention structure that operates during normal times as in the shock absorbing member disclosed in Patent Literature 2.

[C] When a shock P is applied, the viscous body V filling the resin tube 35a leaks out not to the outside of the shock absorbing member as in the shock absorbing member according to Patent Literature 2, but to the inside of the resin tubes 35b not filled with the viscous body V. Therefore, it is not absolutely necessary to secure a gap that receives the viscous body V that has leaked out between the shock absorbing member 9 and the bumper reinforcement 8 (to which the shock absorbing member 9 is attached) as in the shock absorbing member disclosed in Patent Literature 2.

[D] When a shock P is applied, the viscous body V leaks out from a crack in the resin tube 35a. Thus, the crack is expanded to make it more or less easy for the viscous body V to leak out in the case where the viscosity of the viscous body V is high (that is, in the case where the viscous body V does not leak out easily), while the crack is not expanded very much in the case where the viscosity of the viscous body V is low (that is, in the case where the viscous body V leaks out easily). Therefore, the magnitude of the friction (flow resistance) during leakage is not easily affected by the difference in viscosity of the viscous body V compared to a case where the viscous body leaks out from a through hole provided in advance as in the shock absorbing member according to Patent Literature 2.

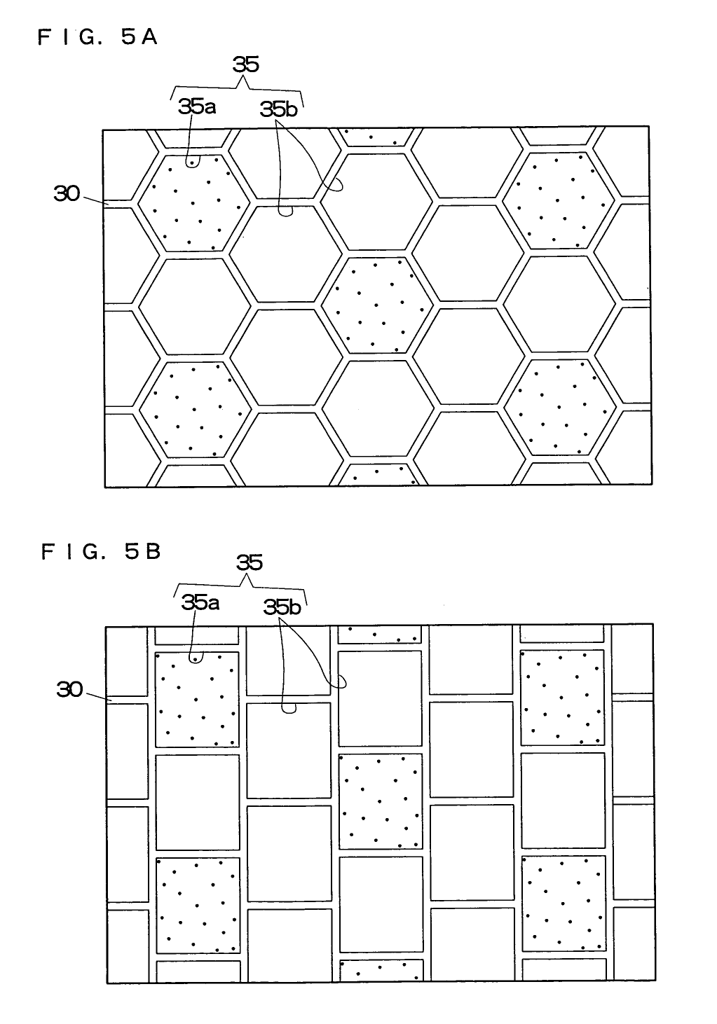

The present invention is not limited to the above embodiment, and the construction and the shape of various components may be modified appropriately without departing from the scope and spirit of the present invention. For example, the shape of the grid-like resin rib 30 according to the embodiment shown in FIG. 5A may be modified as given in modified examples 1 to 5 below.

### Modified Embodiment 1

The grid-like resin rib 30 according to the modified example 1 shown in FIG. 5B is the same as the grid-like resin rib 30 according to the embodiment in the arrangement of the centers of the resin tubes 35, 35, . . . , but is different in that the resin tubes 35, 35, . . . are quadrangular, rather than hexagonal, as viewed from the front.

### Modified Embodiment 2

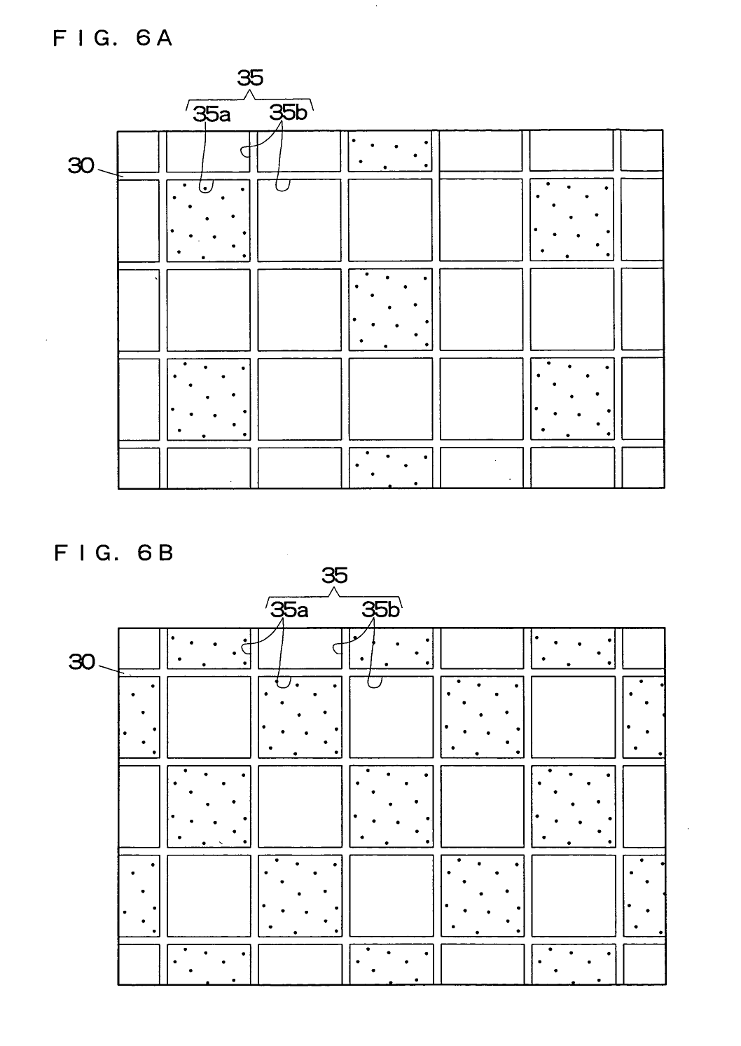

The grid-like resin rib 30 according to the modified example 2 shown in FIG. 6A forms a quadrangular grid as viewed from the front, with respective cells of the quadrangular grid forming the resin tubes 35, 35, . . . . Of the resin tubes 35, 35, . . . , one-fourth of the resin tubes, 35a, 35a, . . . , which are selected so as to be arranged discontinuously, are filled with a viscous body V, and the remaining three-fourths of the resin tubes, 35b, 35b, . . . , are not filled with the viscous body V.

### Modified Embodiment 3

The grid-like resin rib 30 according to the modified example 3 shown in FIG. 6B forms a quadrangular grid as viewed from the front, with respective cells of the quadrangular grid forming the resin tubes 35, 35, . . . , as in the grid-like resin rib 30 according to the modified example 2. Of the resin tubes 35, 35, . . . , a half of the resin tubes, 35a, 35a, . . . , which are selected so as to be arranged discontinuously, are filled with a viscous body V, and the remaining half of the resin tubes, 35b, 35b, . . . , are not filled with the viscous body V.

### Modified Embodiment 4

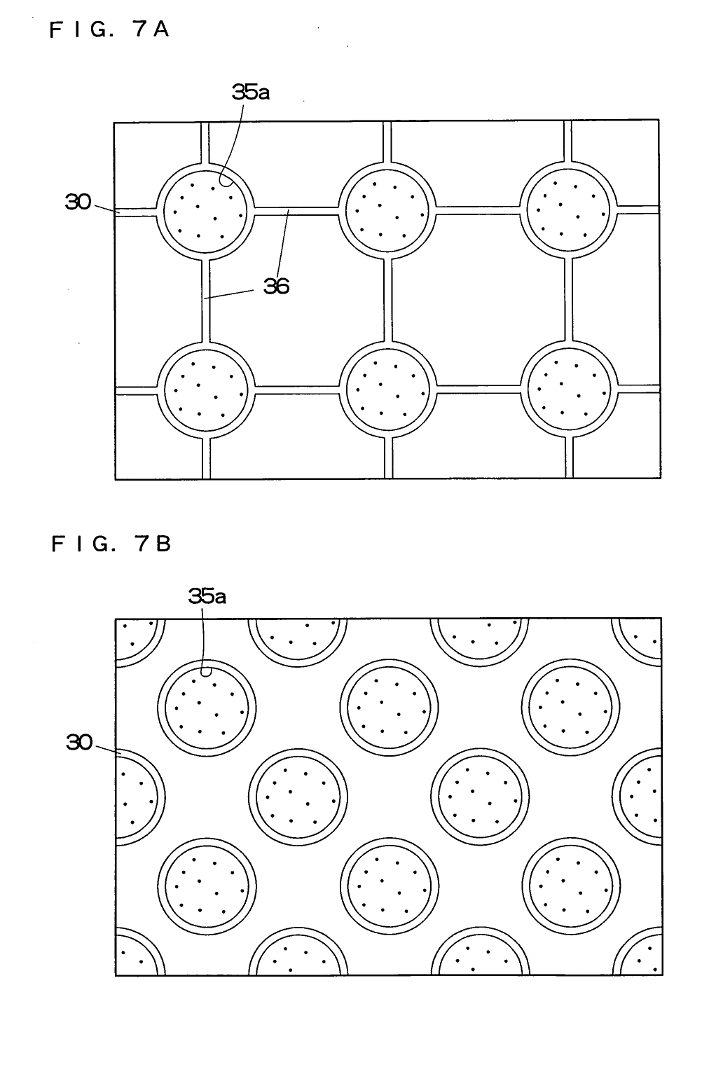

The grid-like resin rib 30 according to the modified example 4 shown in FIG. 7A is formed from a plurality of resin tubes 35a, 35a, . . . , which are circular (cylindrical) as viewed from the front and filled with a viscous body V, and coupling portions 36, 36, . . . that couple the resin tubes 35a, 35a, . . . with each other.

### Modified Embodiment 5

The grid-like resin rib 30 according to the modified example 5 shown in FIG. 7B is formed from a plurality of resin tubes 35a, 35a, . . . which are circular (cylindrical) as viewed from the front and filled with a viscous body V. The resin tubes 35a, 35a, . . . are isolated from each other with tube walls thereof not coupled with each other.

### REFERENCE SIGNS LIST

9 SHOCK ABSORBING MEMBER
10 FRONT PLATE
20 BACK PLATE
30 GRID-LIKE RESIN RIB
35 RESIN TUBE
35a RESIN TUBE FILLED WITH VISCOUS BODY
V VISCOUS BODY

1. A shock absorbing member comprising:
a pair of opposing plates (10, 20); and
a plurality of resin tubes (35a) internally filled with a viscous body (V), both end surfaces of the resin tubes (35a) being closed by the pair of the plates (10, 20),
wherein each resin tube is disposed between the pair of the plates (10, 20) and is surrounded by a space not filled with the viscous body (V), and
wherein when a shock (P) in a direction of bringing the pair of the plates (10, 20) closer to each other is applied, the resin tube (35a) is buckled toward the surrounding space and the viscous body (V) leaks out from a crack generated in the resin tube (35a) by the buckling to absorb the shock (P).

2. The shock absorbing member according to claim 1, wherein
the plurality of the resin tubes (35a) filled with the viscous body (V) are part of a plurality of resin tubes (35) forming respective cells of a grid-like resin rib (30) that are selected so as to be arranged discontinuously.

3. The shock absorbing member according to claim 1, wherein
the plurality of the resin tubes (35a) filled with the viscous body (V) are isolated from each other with tube walls thereof not coupled to each other.

4. The shock absorbing member according to claim 1, wherein
one (20) of the pair of the plates (10, 20) and the plurality of the resin tubes (35a) filled with the viscous body (V) are integrally formed from a resin.

5. The shock absorbing member according to claim 1, wherein the viscous body (V) is formed by adding at least oil to a thermoplastic elastomer.
